(19) United States
(12) Patent Application Publication
(10) Pub. No.: US 2024/0408694 A1
(43) Pub. Date: Dec. 12, 2024

(54) Ultrasonic Welding Apparatus and Electrode Assembly Manufactured Thereby

(71) Applicant: LG Energy Solution, Ltd., Seoul (KR)

(72) Inventor: Gi Hwan Kwon, Daejeon (KR)

(73) Assignee: LG Energy Solution, Ltd., LG Energy Solution, Ltd. (KR)

(21) Appl. No.: 18/699,737

(22) PCT Filed: Nov. 15, 2022
(86) PCT No.: PCT/KR2022/018000

§ 371 Date: Apr. 9, 2024

(30) Foreign Application Priority Data
Nov. 30, 2021 (KR) 10-2021-0169084

(51) Int. Cl. B23K 20/10; B23K 101/36; H01M 50/536; H01M 50/54

(52) U.S. Cl. CPC B23K 20/106; H01M 50/536; H01M 50/54; B23K 2101/36

(57) ABSTRACT

An ultrasonic welding apparatus, configured to weld a plurality of electrode tabs of an electrode assembly to each other, includes an anvil disposed at one side of the plurality of electrode tabs; a horn disposed to face the anvil with the plurality of electrode tabs therebetween; and a protrusion part provided on at least one of the anvil and the horn to face the plurality of electrode tabs. The protrusion part may include: an inner protrusion part in which a plurality of first protrusions are arranged along a first direction parallel to a width direction of the electrode tabs; and a pair of outer protrusion parts which are disposed at both sides of the inner protrusion part in a second direction orthogonal to the first direction and in which a plurality of second protrusions are arranged an interval wider than that between the plurality of first protrusions.

### CROSS-REFERENCE TO RELATED APPLICATIONS

The present application is a national phase entry under 35 U.S.C. 371 of International Application No. PCT/KR2022/018000 filed on Nov. 15, 2022, which claims the benefit of the priority of Korean Patent Application No. 10-2021-0169084, filed on Nov. 30, 2021, all of which is hereby incorporated herein by reference in its entirety.

### TECHNICAL FIELD

The present disclosure relates to an ultrasonic welding apparatus for welding a plurality of electrode tabs of an electrode assembly, and an electrode assembly manufactured by the ultrasonic welding apparatus.

### BACKGROUND ART

Secondary batteries are rechargeable unlike primarily batteries, and also, the possibility of compact size and high capacity is high. Thus, recently, many studies on secondary batteries are being carried out. As technology development and demands for mobile devices increase, the demands for secondary batteries as energy sources are rapidly increasing.

Rechargeable batteries are classified into coin type batteries, cylindrical type batteries, prismatic type batteries, and pouch type batteries according to a shape of a battery case. In such a secondary battery, an electrode assembly mounted in a battery case is a chargeable and dischargeable power generating device having a structure in which an electrode and a separator are stacked.

The electrode assembly may be approximately classified into a jelly-roll type electrode assembly in which a separator is interposed between a positive electrode and a negative electrode, each of which is provided as the form of a sheet coated with an active material, and then, the positive electrode, the separator, and the negative electrode are wound, a stacked type electrode assembly in which a plurality of electrodes with a separator therebetween are sequentially stacked, and a stack & folding type electrode assembly in which stacked type unit cells are wound together with a separation film having a long length.

Particularly, each of the stack type or stack and folding type electrode assemblies includes electrode tabs connected to the plurality of electrodes, and the plurality of electrode tabs are generally welded to each other by an ultrasonic welding apparatus. However, since each of the electrode tabs has a thickness of several micrometers, an ultrasonically welded portion may be easily broken by disturbance or the like. Therefore, the ultrasonic welding apparatus for solving these concerns is required.

### DISCLOSURE

### Technical Problem

One object of the embodiments of the present invention for solving this problem is to provide an ultrasonic welding apparatus that minimizes a risk of breakage or cracks occurring in a welded portion at which a plurality of electrode tabs are welded.

Another object of the embodiments of the present invention for solving the above problem is to provide an electrode assembly manufactured by the ultrasonic welding apparatus.

### Technical Solution

An ultrasonic welding apparatus may weld a plurality of electrode tabs of an electrode assembly to each other. The ultrasonic welding apparatus may include: an anvil disposed at one side of the plurality of electrode tabs; a horn disposed to face the anvil with the plurality of electrode tabs therebetween; and a protrusion part provided on at least one of the anvil and the horn to face the plurality of electrode tabs. The protrusion part may include: an inner protrusion part in which a plurality of first protrusions are arranged along a first direction parallel to a width direction of the electrode tabs; and a pair of outer protrusion parts which are disposed at both sides of the inner protrusion part in a second direction orthogonal to the first direction and in which a plurality of second protrusions are arranged an interval wider than that between the plurality of first protrusions.

A length of the protrusion part in the first direction may be less than a width of each of the electrode tab.

An interval between each of both ends of the protrusion part and each of both edges of the electrode tab may be 1/45 to 1/30 of the width of the electrode tab.

A length of the inner protrusion part may be greater than that of the outer protrusion part in the first direction.

The pair of outer protrusion parts may have a symmetrical shape with respect to the inner protrusion part.

In the inner protrusion part, the plurality of first protrusions may be arranged to form a plurality of columns along the first direction.

In the outer protrusion part, the plurality of second protrusions may be arranged along a virtual curve line.

The curve line may form a portion of an ellipse.

A distance between the inner protrusion part and the outer protrusion part in the second direction may gradually decrease outward in the first direction.

A maximum distance between the inner protrusion part and the outer protrusion part in the second direction may be 0.5 times to 0.75 times a width of the inner protrusion part in the second direction.

An electrode assembly may include: a plurality of electrodes stacked with a separator therebetween; a plurality of electrode tabs connected to the plurality of electrodes; and a welded portion, which is formed by welding the plurality of electrode tabs to each other. The welded portion may include: an inner embo pattern extending along a first direction parallel to a width direction of each of the electrode tabs; and outer embo patterns disposed at both sides of the inner embo pattern in a second direction orthogonal to the first direction and formed at an interval wider than that between the inner embo patterns.

The welded portion may include a flat part which is provided at a portion of both the sides in the width direction and on which the inner embo pattern and the outer embo pattern are not formed.

A width of the flat part may be 1/45 to 1/30 of a width of the electrode tab.

A length of the inner embo pattern may be greater than that of the outer embo pattern in the first direction.

The pair of outer embo patterns may have a symmetrical shape with respect to the inner embo pattern.

The inner embo pattern may form a plurality of columns in the first direction.

The outer embo patterns may be formed along a virtual curve line.

The curve line may form a portion of an ellipse.

A distance between the inner embo pattern and the outer embo pattern in the second direction may gradually decrease outward in the first direction.

A maximum distance between the inner embo pattern and the outer embo pattern in the second direction may be 0.5 times to 0.75 times a width of the inner embo pattern in the second direction.

### Advantageous Effects

According to a preferred embodiment of the present invention, the distance between the plurality of second embossings provided in the outer embo pattern may be greater than that between the plurality of first embossings constituting the inner embo pattern. Thus, the possibility of breakage or cracks occurring at the welded boundary due to the disturbance may be reduced, and even though the breakage or cracks occurs, the expansion of the breakage or cracks may be minimized.

In addition, the outer embo pattern may be formed along the curve line. Therefore, the possibility of breakage or cracks occurring at the welded boundary due to the disturbance may be more reduced, and even though the breakage or cracks occurs, the expansion of the breakage or cracks may be minimized.

In addition, since the embo pattern is not formed on the portion of both the sides of the welded portion in the width direction, the risk of the breakage or cracks occurring at both the edges of the welded portion may be minimized.

In addition, the effects that are obvious to those skilled in the art may be predicted from the configurations according to the embodiments of the present invention.

### BRIEF DESCRIPTION OF THE DRAWINGS

The following drawings attached in this specification illustrate a preferred embodiment of the present invention and function to make further understood the technical spirit of the present invention along with the detailed description of the embodiments of the invention, and thus, the present invention should not be construed as being limited to only the drawings.

FIG. 1 is a schematic view of an ultrasonic welding apparatus according to an embodiment of the present invention.

FIG. 2 is an enlarged view of a protrusion part according to an embodiment of the present invention.

FIG. 3 is a perspective view of an electrode assembly according to another embodiment of the present invention.

FIG. 4 is a plan view illustrating a welded portion of the electrode assembly according to another embodiment of the present invention.

FIG. 5 is an enlarged view of a protrusion part according to a comparative example of the present invention.

FIG. 6 is a plan view illustrating a welded portion of an electrode assembly according to the comparative example of the present invention.

### MODE FOR CARRYING OUT THE INVENTION

Hereinafter, preferred embodiments of the present invention will be described in detail with reference to the accompanying drawings so that those of ordinary skill in the art can easily carry out the present invention. However, embodiments of the present invention may be implemented in several different forms and is not limited or restricted by the following examples.

In order to clearly explain embodiments of the present invention, detailed descriptions of portions that are irrelevant to the description or related known technologies that may unnecessarily obscure the gist of the present disclosure have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present disclosure on the basis of the principle that an inventor can properly define the concept of a term to describe and explain his or her invention in the best ways.

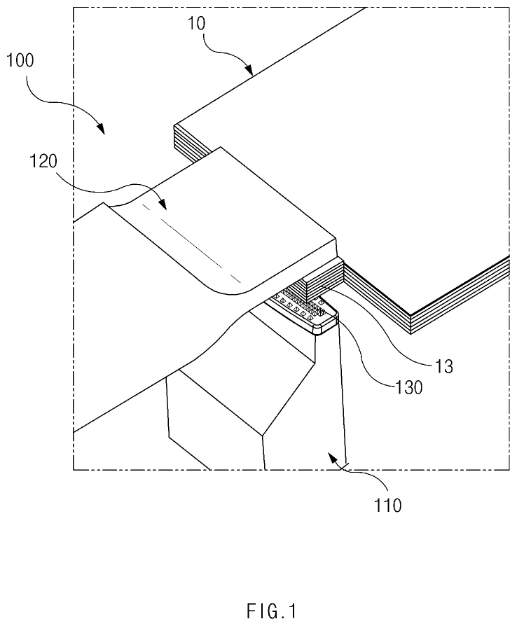

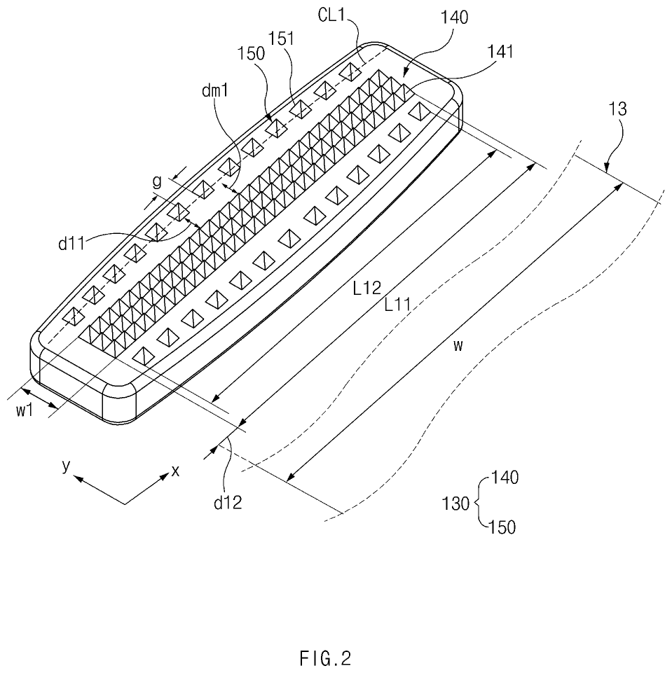

FIG. 1 is a schematic view of an ultrasonic welding apparatus according to an embodiment of the present invention, and FIG. 2 is an enlarged view of a protrusion part according to an embodiment of the present invention.

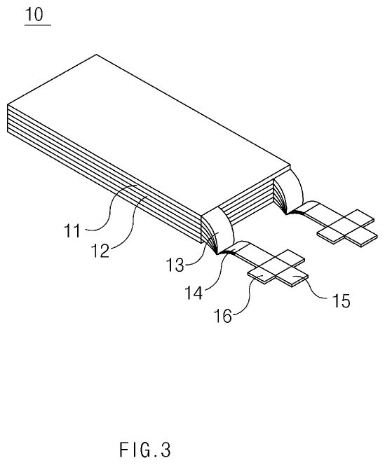

The ultrasonic welding apparatus 100 (hereinafter, referred to as a welding apparatus) according to this embodiment may weld a plurality of electrode tabs 13 of an electrode assembly 10 to each other. The welding apparatus 100 may form a welded portion 14 (see FIG. 3, hereinafter, referred to as a welded portion) by welding the plurality of electrode tabs 13. That is, the welded portion 14 may be a portion at which the plurality of electrode tabs 13 are welded to each other.

In more detail, the welding apparatus 100 may include an anvil 110 disposed at one side of the plurality of electrode tabs 13, a horn 120 facing the anvil 110 with the plurality of electrode tabs 13 therebetween, and a protrusion part 130 provided on at least one of the anvil 110 or the horn 120 to face the plurality of electrode tabs 13.

The anvil 110 may be disposed below the plurality of electrode tabs 13, and the horn 120 may be disposed above the plurality of electrode tabs 13.

A mutual distance of the anvil 110 and the horn 120 may be adjusted. For example, the horn 120 may be configured so that the distance to the anvil 110 is adjustable. Thus, the plurality of electrode tabs 13 may be pressed between the anvil 110 and the horn 120, and in this state, the horn 120 may vibrate at a high frequency to weld the plurality of electrode tabs 13 to each other. In more detail, ultrasonic waves generated by a vibrator may be amplified by a booster and then transmitted to the horn 120. Therefore, the horn 120 may press the plurality of electrode tabs 13 disposed on the anvil 110 at a certain load and also apply the amplified ultrasonic waves transmitted from the booster to the electrode tabs 13 to weld the plurality of electrode tabs 13 to each other. Since the configurations and operations of the ultrasonic vibrator and the booster are well-known, their detailed descriptions will be omitted.

The protrusion part 130 may be provided on at least one of the anvil 110 or the horn 120. Hereinafter, a case in which the protrusion part 130 is provided on each of the anvil 110 and the horn 120 will be described as an example.

Each of the protrusion parts 130 may face the plurality of electrode tabs 13. In more detail, one protrusion part 130 may be provided on a bottom surface of the anvil 110, and the other protrusion part 130 may be provided on a bottom surface of the horn 120. The protrusion part 130 provided on the anvil 110 may face the lower outermost electrode tab of the plurality of electrode tabs 13, and the protrusion part 130 provided on the horn 120 may face the upper outermost electrode tab of the plurality of electrode tabs 13. The protrusion part 130 provided on the anvil 110 may press the plurality of electrode tabs 13 at a lower side, and the protrusion part 130 provided on the horn 120 may press the plurality of electrode tabs 13 at an upper side.

The protrusion part 130 may include a plurality of protrusions 141 and 151 protruding toward the electrode tab 13. The plurality of protrusions 141 and 151 include a plurality of first protrusions 141 provided in an inner protrusion part 140 to be described later and a plurality of second protrusions 151 provided in an outer protrusion part 150 to be described later. The first protrusion 141 and the second protrusion 151 may have the same size and shape, but are not limited thereto.

Each of the protrusions 141 and 151 may have a cross-sectional area that is gradually narrowed as it approaches the electrode tab 13. For example, each of the protrusions 141 and 151 may have a substantially polygonal pyramid shape.

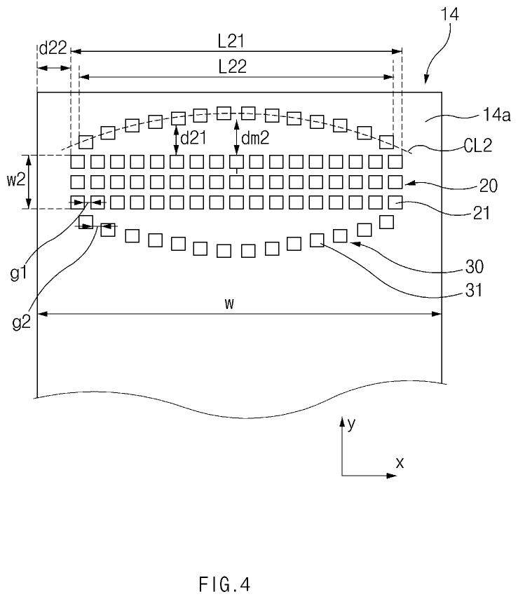

A plurality of embo patterns 20 and 30 (see FIG. 4) corresponding to the plurality of protrusions 131 and 141 may formed on the welded portion 14 (see FIG. 3) formed by welding the electrode tabs 13. This will be described in detail later.

In more detail, the protrusion part 130 may include the inner protrusion part 140 arranged along a first direction (a direction parallel to an x-axis of FIG. 2) parallel to a width direction of the electrode tab 13 and a pair of outer protrusion parts 150 disposed at both sides of the inner protrusion 140 in a second direction (a direction parallel to a y-axis of FIG. 2) and arranged at an interval wider than that between the plurality of first protrusions 141.

The inner protrusion part 140 may be formed by grouping the plurality of first protrusions 141. The inner protrusion part 140 may be arranged so that the plurality of first protrusions 141 form at least one row in the first direction. Preferably, the inner protrusion part 140 may be arranged so that the plurality of first protrusions 141 form a plurality of rows in the first direction.

The pair of outer protrusion parts 150 may have a symmetrical shape with respect to the inner protrusion part 140. However, this embodiment is not limited thereto.

Each of the outer protrusion parts 150 may be formed by grouping the plurality of second protrusions 151. In each of the outer protrusion parts 150, the plurality of second protrusions 151 may be arranged along a virtual curve line CL1. That is, each of the outer protrusion parts 150 may be formed along the curve line CL1. The curve line CL1 may form a portion of an ellipse.

The number of columns formed by the plurality of second protrusions 151 may be less than the number of columns formed by the plurality of first protrusions 141. For example, the plurality of second protrusions 151 may be arranged to form a single column along the curve line CL1, and the plurality of first protrusions 141 may be arranged to form a plurality of columns along the first direction.

Since the outer protrusion part 150 is formed along the curve line CL1, an outer embo pattern 30 (see FIG. 4) to be described later may also be formed along the curve line CL2.

A distance g between the plurality of second protrusions 151 provided in the outer protrusion part 150 may be wider than that between the plurality of first protrusions 141 provided in the inner protrusion part 140. For example, the plurality of first protrusions 141 may be disposed adjacent to each other without forming an interval, and an interval between the plurality of second protrusions 151 may be greater than or equal to a width of each of the second protrusions 151.

In the first direction, a length L11 of the inner protrusion part 140 may be longer than a length L12 of the outer protrusion part 150. In the first direction, the length L11 of the inner protrusion part 140 may mean a length of the protrusion part 130.

The length of the protrusion part 130 in the first direction may be less than a width w of the electrode tab 13. That is, the length L11 of the inner protrusion part 140 in the first direction may be less than the width w of the electrode tab 13.

In more detail, a predetermined interval d12 may be formed between each of both ends of the protrusion part 130 and each of both edges of the electrode tab 13. An interval d12 may be 1/45 to 1/30 of the width w of the electrode tab 13. For example, the width w of the electrode tab 13 may be about 45 mm, and the interval d12 may be about 1 mm to about 1.5 mm.

As a result, while reliably welding the plurality of electrode tabs 13, a flat part 14a on which the embo patterns 20 and 30 are not formed at both edges in the width direction of the welded portion 14 (see FIG. 4) to be described later may be formed.

A distance d11 between the inner protrusion part 140 and the outer protrusion part 150 in the second direction may gradually decrease outward in the first direction. Thus, the distance d11 between the inner protrusion part 140 and the outer protrusion part 150 in the second direction may be a maximum distance dm1 at a central portion of the protrusion part 130 in the first direction.

The maximum distance dm1 between the inner protrusion part 140 and the outer protrusion part 150 in the second direction may be 0.5 times to 0.75 times the width w1 of the inner protrusion part 140 in the second direction. For example, the width w1 of the inner protrusion part 140 may be about 4 mm, and the maximum distance dm1 between the inner protrusion part 140 and the outer protrusion part 150 may be about 2 mm to 3 mm.

As a result, while reliably welding the plurality of electrode tabs 13, breakage or cracks that may occur in the welded portion 14 (see FIG. 4) to be described later may be prevented from being expanded.

FIG. 3 is a perspective view of an electrode assembly according to another embodiment of the present invention, and FIG. 4 is a plan view illustrating a welded portion of the electrode assembly according to another embodiment of the present invention.

Hereinafter, an electrode assembly 10 manufactured by the above-described ultrasonic welding apparatus 100 will be described as another embodiment of the present invention.

The electrode assembly 10 according to this embodiment may include a plurality of electrodes 11 stacked with a separator 12 therebetween, a plurality of electrode tabs 13 connected to the plurality of electrodes 11, and a plurality of welded portions, which are formed by welding the plurality of electrode tabs 13 to each other.

Each of the electrodes 11 may be formed by applying active material slurry to an electrode collector in the form of a metal foil or a metal mesh. The electrodes 11 may be classified as positive electrodes or negative electrodes, Here, the positive electrode collector may include an aluminum material, and the negative electrode collector may include a copper material. The positive electrode and the negative electrode may be alternately stacked with the separator 12 therebetween.

Each of the electrode tab 13 may protrude from the electrode 11 to act as a path through which electrons move between the inside and outside of the electrode assembly 10 together with an electrode lead 15.

The plurality of electrode tabs 13 connected to the positive electrode and the plurality of electrode tabs 13 connected to the negative electrode among the plurality of electrodes 12 may protrude in the same direction with respect to the electrode assembly 10 as illustrated in FIG. 3. However, the present invention is not limited thereto, and the plurality of electrode tabs 13 connected to the positive electrode and the plurality of electrode tabs 13 connected to the negative electrode may protrude in directions opposite to each other with respect to the electrode assembly 10.

A portion of the plurality of electrode tabs 13 may be welded to each other to form a welded portion 14. The plurality of electrode tabs 13 may get closer to each other toward the welded portion 14. A width of the welded portion 14 may be the same as that of the electrode tab 12. The welded portion 14 may be formed by the ultrasonic welding apparatus 100 described above.

The plurality of electrode tabs 13, more specifically, the electrode lead 15 may be connected to the welded portion 14 by spot welding or the like. When the electrode assembly 10 is accommodated in a battery case (not shown), one end of the electrode lead 15 may be connected to the plurality of electrode tabs 15, and the other end may protrude to the outside of the battery case.

A portion of the electrode lead 15 may be surrounded by an insulating part 16. For example, the insulating part 16 may include an insulating tape. The insulating part 16 may prevent electricity generated in the electrode assembly 10 from flowing to the battery case through the electrode lead 15. Since this is a well-known technique, a detailed description thereof will be omitted.

Referring to FIG. 4, embo patterns 20 and 30 may be formed on the welded portion 14. The embo patterns 20 and 30 may be formed by the protrusion parts 130 of the ultrasonic welding apparatus 10. The characteristics of the embo patterns 20 and 30 may correspond to the characteristics of the protrusion parts 130 described above.

The embo patterns 20 and 30 may include a plurality of embossings 21 and 31. The plurality of embossings 21 and 31 include a plurality of first embossings 21 provided in an inner embo pattern 20 to be described later and a plurality of second embossings 31 provided in an outer embo pattern 30 to be described later. The first embossing 21 and the second embossing 31 may have the same size and shape, but are not limited thereto.

The embo patterns 20 and 30 may include an inner embo pattern 20 formed by an inner protrusion part 140 of the ultrasonic welding apparatus 10 and an outer embo pattern 30 formed by an outer protrusion part 150 of the ultrasonic welding apparatus 10.

Hereinafter, it will be described in more detail with reference to FIGS. 2 and 4 together.

The inner embo pattern 20 extending along a first direction (a direction parallel to an x-axis of FIG. 4) parallel to a width direction of the electrode tab 13 and outer embo patterns 30 disposed at both sides of the inner embo pattern 20 with respect to a second direction (a direction parallel to a y-axis of FIG. 4) orthogonal to the first direction and formed at an interval wider than that between the inner embo pattern 20 may be formed on the welded portion 14.

The inner embo pattern 20 may be formed by grouping the plurality of first embossings 21. The inner embo pattern 20 may be arranged so that the plurality of first embo patterns 21 form at least one row in the first direction. Preferably, the inner embo pattern 20 may be arranged so that the plurality of first embo patterns 21 form a plurality of rows in the first direction.

The pair of outer embo patterns 30 may have a symmetrical shape with respect to the inner embo pattern 20. However, this embodiment is not limited thereto.

The pair of outer embo patterns 30 may form a welded boundary.

Each of the outer embo patterns 30 may be formed by grouping the plurality of second embossings 31. The outer embo patterns 30 may be arranged so that the plurality of second embossings 31 are arranged along a virtual curve line CL2. That is, the outer embo patterns 30 may be formed along the curve line CL2. The curve line CL2 may form a portion of an ellipse. The curve line CL2 may correspond to a curve line CL1 formed by the outer protrusion part 150 of the ultrasonic welding apparatus 100.

The number of columns formed by the plurality of second embossings 31 may be less than the number of columns formed by the plurality of first embossings 21. For example, the plurality of second embossings 31 may be arranged to form a single column along the curve line CL2, and the plurality of first embossings 21 may be arranged to form a plurality of columns along the first direction.

Since the outer embo pattern 30 is formed along the curve line CL2, the welded boundary may form the curve line.

An interval g2 between the plurality of second embossings 31 provided in the outer embo pattern 30 may be wider than an interval g1 between the plurality of first embossings 21 provided in the inner embo pattern 20.

Thus, a risk of breakage or cracks occurring due to disturbance at the welded boundary may be reduced, and even if the breakage or cracks occur, expansion of the breakage or cracks may be restricted.

In the first direction, a length L21 of the inner embo pattern 20 may be longer than a length L22 of the outer embo pattern 30. The length L21 of the inner embo pattern 20 may be equal to or slightly shorter than a length L11 of the inner protrusion part 140 of the ultrasonic welding apparatus 100. The length L22 of the outer embo pattern 30 may be equal to or slightly shorter than a length L12 of the outer protrusion part 150 of the ultrasonic welding apparatus 100.

In the first direction, the length L21 of the inner embo pattern 20 may mean a length of each of the embo patterns 20 and 30.

The length of each of the embo patterns 20 and 30 in the first direction may be less than a width w of the electrode tab 13. That is, the length L11 of the inner embo pattern 20 in the first direction may be less than the width w of the welded portion 14.

The welded portion 14 may include a flat part 14a which is provided at each of both sides in the width direction and on which the inner embo pattern 20 and the outer embo pattern 30 are not formed. The embo patterns 20 and 30 may not be formed on some of both sides of the welded portion 14 in the width direction. As a result, the embo patterns 20 and 30 may not invade both edges of the welded portion 14 in the width direction or may not be formed adjacent to both the edges of the welded portion 14 in the width direction, and thus, the risk of damage such as cracks or breakage at both the edges of the welded portion 14 in the width direction may be minimized.

A width d22 of the flat part 14a may be 1/45 to 1/30 of the width w of the electrode tab 13, that is, the width w of the welded portion 14. For example, the width w of the electrode tab 13 may be about 45 mm, and the width d22 of the flat part 14a may be 1 mm to 1.5 mm.

As a result, while the welded portion 14 is stably maintained, the risk of the damage such as the cracks or the breakages at both the edges of the welded portion 14 in the width direction may be minimized. If the width d22 of the flat part 14a is less than 1/45 of the width w of the electrode tab 13, each of the embo patterns 20 and 30 may be too close to both the edges of the welded portion 14 in the width direction, and thus, the risk of the damage such as the cracks or the breakage may occur at both the edges of the welded portion 14 in the width direction. Conversely, when the width d22 of the flat part 14a exceeds 1/30 of the width w of the electrode tab 13, welding force between the plurality of electrode tabs 13 may be weakened, and the welded portion 14 may not be maintained stably.

A distance d21 between the inner embo pattern 20 and the outer embo pattern 30 in the second direction may gradually decrease outward in the first direction. Therefore, the distance d21 between the inner embo pattern 20 and the outer embo pattern 30 in the second direction may be a maximum distance dm2 at a center of the welded portion 14 in the first direction.

The maximum distance dm2 between the inner embo pattern 20 and the outer embo pattern 30 in the second direction may be 0.5 times to 0.75 times the width w2 of the inner embo pattern 20 in the second direction. For example, the width w2 of the inner embo pattern 20 may be about 4 mm, and the maximum distance dm2 between the inner embo pattern 20 and the outer embo pattern 30 may be about 2 mm to 3 mm.

As a result, the welded portion 14 may be stably maintained while restricting the expansion of the breakage or the cracks that may occur in the inner embo pattern 20. If the maximum distance dm2 is less than 0.5 times the width w2 of the inner embo pattern 20, since a line formed by the outer embo pattern 30 approaches a straight line rather than a curved line CL2, it may be difficult to exert the effect of restricting the expansion of the breakage or the cracks that may occur at the inner embo pattern 20. Conversely, when the maximum distance dm2 is greater than 0.75 times the width w2 of the inner embo pattern 20, an arrangement density per unit area of the embo patterns 20 and 30 may be too low, and thus, the welding force between the plurality of electrode tabs 13 may be weakened, and the welded portion 14 may not be stably maintained.

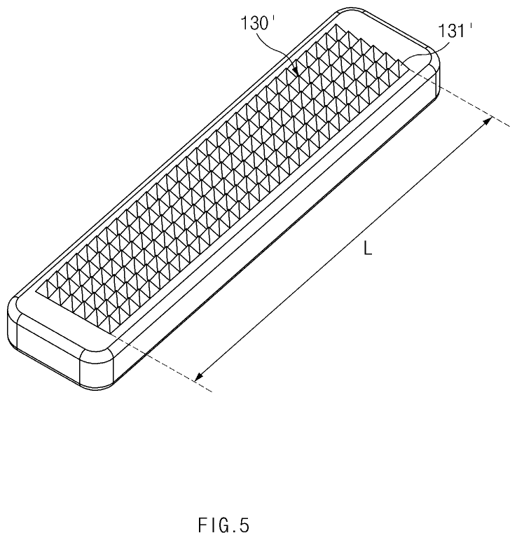

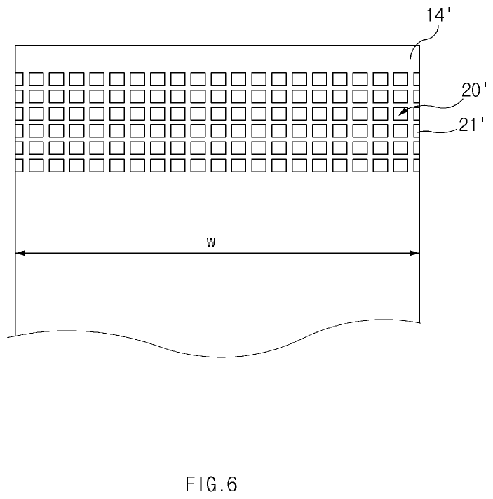

FIG. 5 is an enlarged view of a protrusion according to a comparative example of the present invention, and FIG. 6 is a plan view illustrating a welded portion of an electrode assembly according to the comparative example of the present invention.

Referring to FIGS. 5 and 6, a length L of a protrusion part 130′ according to a comparative example may be equal to or greater than a width w of a welded portion 14′. Thus, an embo pattern 20′ formed on the welded portion 14′ by the protrusion part 130′ may invade or be adjacent to both edges of the welded portion 14′ in a width direction. As a result, there is a high possibility that damage such as cracks or breakage may occur at both edges of the welded portion 14′ in the width direction.

In addition, a plurality of protrusions 131′ provided in the protrusion part 130′ may be arranged at regular intervals. Therefore, a plurality of embossings 21′ provided in the embo pattern 20′ formed on the welded portion 14′ may also be arranged at regular intervals, and the welded boundary may form a straight line.

As a result, the breakage or cracks may easily occur at a boundary of the embo pattern 20′, and there is a problem in that the breakage or the cracks are quickly expanded.

According to this comparative example, those skilled in the art will be able to more easily understand the configuration and effect of the present invention.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present invention is to be considered illustrative, and not restrictive, and the technical spirit of the present invention is not limited to the foregoing embodiment.

Therefore, the scope of the present disclosure is defined not by the detailed description of the invention but by the appended claims, and all differences within the scope will be construed as being included in the present disclosure.

### DESCRIPTION OF THE SYMBOLS

10: Electrode assembly
11: Electrode
12: Separator
13: Electrode tab
14: Welded portion
15: Electrode lead
20: Inner embo pattern
21: First embossing
30: Outer embo pattern
31: Second embossing
100: Ultrasonic welding apparatus
110: Anvil
120: Horn
130: Protrusion part
140: Inner protrusion part
141: First protrusion
150: Outer protrusion part
151: Second protrusion

1. An ultrasonic welding apparatus for welding a plurality of electrode tabs of an electrode assembly to each other, the ultrasonic welding apparatus comprising:
an anvil disposed at one side of the plurality of electrode tabs;
a horn disposed to face the anvil with the plurality of electrode tabs therebetween; and
a protrusion part disposed on at least one of the anvil and the horn to face the plurality of electrode tabs,
wherein the protrusion part comprises:
an inner protrusion part in which a plurality of first protrusions are arranged along a first direction parallel to a width direction of the electrode tabs; and
a pair of outer protrusion parts in which a plurality of second protrusions are spaced apart by an interval wider than that between the plurality of first protrusions, the pair of outer protrusion parts being disposed on opposite sides of the inner protrusion part in a second direction orthogonal to the first direction.

2. The ultrasonic welding apparatus of claim 1, wherein a length of the inner protrusion part and the pair of outer protrusion parts in the first direction is less than a width of each of the plurality of electrode tabs.

3. The ultrasonic welding apparatus of claim 2, wherein a first interval in the first direction between ends of the inner protrusion part and edges of the plurality of electrode tabs is 1/45 of the width of the plurality of electrode tabs, and
wherein a second interval between ends of the pair of outer protrusion parts in the first direction and edges of the plurality of electrode tabs is 1/30 of the width of the plurality of electrode tabs.

4. The ultrasonic welding apparatus of claim 1, wherein a length of the inner protrusion part is greater than that of the pair of outer protrusion parts in the first direction.

5. The ultrasonic welding apparatus of claim 1, wherein the pair of outer protrusion parts have a symmetrical shape with respect to the inner protrusion part.

6. The ultrasonic welding apparatus of claim 1, wherein, in the inner protrusion part, the plurality of first protrusions are arranged to form a plurality of columns along the first direction.

7. The ultrasonic welding apparatus of claim 1, wherein, in the pair of outer protrusion parts, the plurality of second protrusions are arranged along a virtual curve line.

8. The ultrasonic welding apparatus of claim 7, wherein the virtual curve line forms a portion of an ellipse.

9. The ultrasonic welding apparatus of claim 1, wherein a distance between the inner protrusion part and each of the pair of outer protrusion parts in the second direction gradually decreases in an outward direction toward either end of the inner protrusion part in the first direction.

10. The ultrasonic welding apparatus of claim 9, wherein a maximum distance between the inner protrusion part and each of the pair of outer protrusion parts in the second direction is 0.5 to 0.75 times a width of the inner protrusion part in the second direction.

11. An electrode assembly comprising:
a plurality of electrodes stacked with a separator therebetween;
a plurality of electrode tabs connected to the plurality of electrodes; and
a welded portion formed by welding the plurality of electrode tabs to each other,
wherein the welded portion comprises:
an inner emboss pattern extending along a first direction parallel to a width direction of each of the electrode tabs; and
outer emboss patterns disposed on opposite sides of the inner emboss pattern in a second direction orthogonal to the first direction, the outer emboss patterns being spaced at an interval wider than that between markings of the inner emboss pattern.

12. The electrode assembly of claim 11, wherein the welded portion comprises flat parts disposed on opposite sides of the inner emboss pattern in the width direction and on which the inner emboss pattern and the outer emboss patterns are not formed.

13. The electrode assembly of claim 12, wherein a width of each of the flat parts is 1/45 to 1/30 of a width of the plurality of electrode tabs.

14. The electrode assembly of claim 11, wherein a length of the inner emboss pattern is greater than that of the outer emboss patterns in the first direction.

15. The electrode assembly of claim 11, wherein the outer emboss patterns have a symmetrical shape with respect to the inner emboss pattern.

16. The electrode assembly of claim 11, wherein the inner emboss pattern forms a plurality of columns in the first direction.

17. The electrode assembly of claim 11, wherein the outer emboss patterns are formed along a virtual curve line.

18. The electrode assembly of claim 17, wherein the curve line defines a portion of an ellipse.

19. The electrode assembly of claim 11, wherein a distance between the inner emboss pattern and each of the outer emboss patterns in the second direction gradually decreases in an outward direction toward either end of the inner emboss pattern along the first direction.

20. The electrode assembly of claim 19, wherein a maximum distance between the inner emboss pattern and each of the outer emboss patterns in the second direction is 0.5 to 0.75 times a width of the inner emboss pattern in the second direction.
